(19) United States
(12) Patent Application Publication
(10) Pub. No.: US 2025/0222904 A1
(43) Pub. Date: Jul. 10, 2025

(54) Car Ice Pick

(71) Applicant: James Michel, Thornton, CO (US)

(72) Inventor: James Michel, Thornton, CO (US)

(21) Appl. No.: 19/013,295

(22) Filed: Jan. 8, 2025

Related U.S. Application Data
(60) Provisional application No. 63/619,025, filed on Jan. 9, 2024.

(51) Int. Cl. B60S 3/04

(52) U.S. Cl. CPC B60S 3/045

(57) ABSTRACT

The main purpose of the Car Ice Pick is to provide users with an essential tool to effectively remove hard ice accumulation from the surface of an automobile. The disclosure includes a mallet head comprising a bump face and a groove face comprising a groove, a wedge comprising a wide portion and a thin portion, a hinge configured to join the wide portion of the wedge to the mallet head in the groove, and a handle configured to receive the mallet head and provide a grip for a bumping application of the mallet head.

### CROSS REFERENCE

The present Non-Provisional Utility patent application incorporates by reference the Provisional application U.S. 63,619,025 Car Ice Pick in its entirety and is thus entitled to its priority filing date of Jan. 9, 2024.

### BACKGROUND

There are a wide variety of dangers associated with driving vehicles encumbered by hazardous ice that not only compromises steering control and optimal driving functionality but also ice often contains toxins accumulated from the road that remain with the car as it is navigated from point A to point B. The task of manually removing frozen ice from a vehicle, however, can be a tiresome, time-consuming and potentially risky activity especially without a proper tool. There have been no products available as original equipment or as an aftermarket to address this problem.

An apparatus to remove hazardous ice from a vehicle, not just the windshield, with ease and convenience is not being met by any known device or system at present. There have been no products available as original equipment or as an aftermarket to address this problem either.

### SUMMARY OF THE INVENTION

The main purpose of the Car Ice Pick is to provide users with an essential tool to effectively remove hard ice accumulation from the surface of an automobile.

The ice pick includes a mallet head comprising a bump face and a groove face comprising a groove, a wedge comprising a wide portion and a thin portion, a hinge configured to join the wide portion of the wedge to the mallet head in the groove, and a handle configured to receive the mallet head and provide a grip for a bumping application of the mallet head.

### BRIEF DESCRIPTION OF THE DRAWINGS

FIG. 1 is a side perspective view of the Car Ice Pick in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

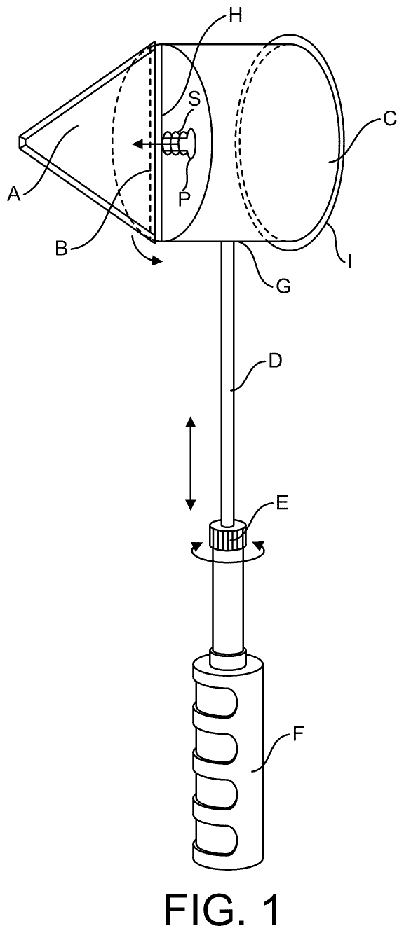

FIG. 1 is a side perspective view of the Car Ice Pick showing: plastic beveled wedge referenced as A, 3-point folding hinges or sleeve hinge referenced as B, rubber mallet head with rounded edge referenced as C, height adjustable bar referenced as D, screw to adjust height referenced as E, rubber grip handle referenced as F, handle molded into mallet referenced as G, a groove H in the groove face, fixed rounded lip I on mallet face C edge in accordance with an embodiment of the present disclosure. The view also includes an anchor pin P which is spring S loaded to pull the wedge A into the groove and lock it there for bumping force from a user's palm on the bump face to dislodge ice.

The present disclosed Car Ice Pick, also known as “Ice Buster”, offers a modern accessory that individuals can use to efficiently and conveniently eliminate the build-up of frozen ice on their vehicle. The Ice Buster introduces a novel tool crafted from a combination of rubber, plastic, and aluminum. Ingenious and practical this invention is able to effortlessly eradicate hardened ice from the automobile and/or commercial vehicle surfaces, such as: fenders, wheel wells, bumpers, shrouds, sideboards and mud flaps. To use the Ice Buster, one would simply hold the tool in their hand and gently swing the rubber mallet side onto the affected areas. The resilient rubber material, combined with the precision of the tool's design dislodges the ice allowing it to safely and swiftly fall away from the vehicle. Not only will the Ice Buster prove invaluable while on the road, but it also prevents the undesired consequences of toxic ice falling off in the garage and/or parking areas. This tool permits a person to address ice management in real-time rather than waiting for it to melt once they arrive at a destination. By using this tool, users eliminate the hassle of cleaning up debris left by the melting ice, ensuring a cleaner and safer environment for themselves and others.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An ice pick comprising:
a mallet head comprising a bump face and a grove face comprising a grove; a wedge comprising a wide portion and a thin portion; a hinge configured to join the wide portion of the wedge to the mallet head in the grove; and a handle configured to receive the mallet head and provide a grip for a bumping application of the mallet head.

2. The ice pick of claim 1, wherein the wedge thin portion comprises a bevel configured to strike ice.

3. The ice pick of claim 1, wherein the handle comprises a rubber grip

4. The ice pick of claim 1, wherein the handle comprises a tenon end configured to join to the mallet head.

5. The ice pick of claim 1, wherein the handle further comprises telescoping segments held in relation to each other via a tightening nut.

6. The ice pick of claim 1, wherein the mallet head defines a mortise configured to receive the handle.

7. The ice pick of claim 1, wherein the hinge further comprises a pin configured to lock the wedge in place in the groove.

8. The ice pick of claim 1, further comprising a spring loaded anchor pin configured in the mallet head to pull the wedge into the groove.

9. The ice pick of claim 1, wherein the thin portion tapers to a point.

10. The ice pick of claim 1, wherein the bump face is configured to receive a force to bump the wedge into dismantling an ice sheet on a vehicle.

11. The ice pick of claim 1, wherein the bump face comprises a rounded end.

12. The ice pick of claim 1, wherein the bump face comprises a rubber material.

13. The ice pick of claim 1, wherein the wedge comprises a hard plastic material.

14. The ice pick of claim 1, wherein a length of the handle is extendable via an adjustable tension nut configured to lock extended portions in place.

15. The ice pick of claim 1, wherein the hinge enables a folding of the wedge against the groove face for a storage of the mallet.
